(19) United States
(12) Patent Application Publication
(10) Pub. No.: US 2013/0185068 A1
(43) Pub. Date: Jul. 18, 2013

(54) SPEECH RECOGNITION DEVICE, SPEECH RECOGNITION METHOD AND PROGRAM

(71) Applicants: Daisuke Tanaka, Tokyo (JP); Takayuki Arakawa, Tokyo (JP)

(72) Inventors: Daisuke Tanaka, Tokyo (JP); Takayuki Arakawa, Tokyo (JP)

(73) Assignee: NEC CORPORATION, Minato-ku, Tokyo (JP)

(21) Appl. No.: 13/823,194

(22) PCT Filed: Sep. 15, 2011
(86) PCT No.: PCT/JP2011/071748

§ 371 Date: Mar. 14, 2013

(30) Foreign Application Priority Data
Sep. 17, 2010 (JP) 2010-209435

(51) Int. Cl. G10L 15/20

(52) U.S. Cl. CPC G10L 15/20
USPC 704/233

(57) ABSTRACT

The present invention provides a speech recognition device includes a threshold value candidate generation unit which extracts a feature indicating likeliness of being speech from a temporal sequence of input sound, and generates a plurality of threshold value candidates for discriminating between speech and non-speech; a speech determination unit which, by comparing the feature indicating likeliness of being speech with the plurality of threshold value candidates, determines respective speech sections, and outputs determination information as a result of the determination; a search unit which corrects each of the speech sections represented by the determination information, using a speech model and a non-speech model; and a parameter update unit which estimates a threshold value for determining a speech section, on the basis of distribution profiles of the feature respectively in utterance sections and in non-utterance sections, within each of the corrected speech sections, and makes an update with the threshold value.

### TECHNICAL FIELD

The present invention relates to a speech recognition device, a speech recognition method and a program, and in particular, to a speech recognition device, a speech recognition method and a program which are robust against background noise.

### BACKGROUND ART

A general speech recognition device extracts features from a temporal sequence of input sound collected by a microphone or the like. The speech recognition device calculates a likelihood with respect to the temporal sequence of features, using a speech model (a model of vocabulary, phoneme or the like) to be a target of recognition and a non-speech model not to be a target of recognition. On the basis of the calculated likelihood, the speech recognition device searches for a word sequence corresponding to the temporal sequence of input sound and outputs the recognition result.

However, if background noise exists, line noise or sudden noise such as a sound of touching a microphone, a wrong recognition result may be obtained. For the purpose of suppressing an adverse effect of such sounds, which are not to be a target of recognition, a plurality of proposals has been made.

A speech recognition device described in non-patent document 1 solves the above-mentioned problem by comparing speech sections calculated respectively in a speech determination process and in a speech recognition process. FIG. 7 is a block diagram showing a functional configuration of a speech recognition device described in non-patent document 1. The speech recognition device of non-patent document 1 is composed of a microphone 11, a framing unit 12, a speech determination unit 13, a correction value calculation unit 14, a feature calculation unit 15, a non-speech model storage unit 16, a speech model storage unit 17, a search unit 18 and a parameter update unit 19.

The microphone 11 collects an input sound. The framing unit 12 cuts out a temporal sequence of input sound collected by the microphone 11 in terms of a frame of a unit of time. The speech determination unit 13 calculates a feature value indicating likeliness of being speech for each of the temporal sequences of input sound cut out in terms of frames, and by comparing it with a threshold value, determines a first speech section.

The correction value calculation unit 14 calculates a correction value for a likelihood with respect to each model from the feature values indicating likeliness of being speech and the threshold value. The feature calculation unit 15 calculates a feature value used in speech recognition from a temporal sequence of input sound cut out in terms of a frame. The non-speech model storage unit 16 stores a non-speech model representing a pattern of other than speeches to be recognition targets.

The speech model storage unit 17 stores a speech model representing a pattern of vocabulary or phonemes of a speech to be a recognition target. Using a feature used in speech recognition for each frame and the speech and non-speech models, and on the basis of a likelihood of the feature with respect to each of the models, which is corrected by the use of the above-mentioned correction value, the search unit 18 searches for a word sequence (recognition result) corresponding to the input sound, and determines a second speech section (utterance section).

To the parameter update unit 19, the first speech section is inputted from the speech determination unit 13, and the second speech section is inputted from the search part 18. Comparing the first and the second speech sections, the parameter update unit 19 updates a threshold value used in the speech determination unit 13.

The speech recognition device of non-patent document 1 compares the first and the second speech sections at the parameter update unit 19, and thus updates a threshold value used in the speech determination unit 13. With the configuration described above, even when a threshold value is not properly set in terms of noise environment or the noise environment varies according to the time, the speech recognition device of non-patent document 1 can accurately calculate a correction value for the likelihood.

Further, non-patent document 1 discloses a method in which, with regard to the second speech section (utterance section) and a section other than the second speech section (non-utterance section), each of the sections is represented in a histogram of a spectral power, and a point of intersection of the histograms is determined to be a threshold value. FIG. 8 is a diagram for illustrating an example of a method of determining a threshold value disclosed in non-patent document 1. As shown in FIG. 8 non-patent document 1 discloses a method in which, setting the occurrence probability of a spectral power of input sound as the ordinate, and the spectral power as the abscissa, a point of intersection of an occurrence probability curve for utterance sections with that for non-utterance sections is determined to be a threshold value.

### CITATION LIST

### Non-Patent Document

[Non-patent document 1] Daisuke Tanaka, “A speech detection method of updating a parameter by the use of a feature over a long term section” Abstracts of Acoustical Society of Japan 2010 Spring Meeting (Mar. 1, 2010).

### SUMMARY OF INVENTION

### Technical Problem

However, when a threshold value for speech determination is determined by the method described in non-patent document 1, if an initially set threshold value deviates far from a proper value, proper determination of a threshold value becomes difficult.

FIG. 9 is a diagram for illustrating a problem in the method of determining a threshold value described in non-patent document 1. For example, owing to a reason such as lack of preliminary survey, a threshold value for determination on an input waveform performed by the speech determination unit 13 at an initial stage of system operation (initial threshold value) may be set to be too low. In that case, the speech recognition system of non-patent document 1 recognizes a section being really a non-speech section as a speech section. If the situation is illustrated by histograms, as shown in FIG. 9, in contrast to that the occurrence probabilities of non-speech sections concentrate extremely within a range of low feature values, the occurrence probabilities of speech sections give a curve broadly spreading over the whole range. As a result, a point of intersection of these two curves is remained to be fairly lower than a desirable threshold value.

Accordingly, the objective of the present invention is to provide a speech recognition device, a speech recognition method and a program, which are capable of estimating an ideal threshold value even when a threshold value set at an initial stage deviates far from a proper value.

### Solution to Problem

In order to achieve the objective described above, one aspect of a speech recognition device in the present invention includes: a threshold value candidate generation unit which extracts a feature indicating likeliness of being speech from a temporal sequence of input sound, and generates threshold value candidates for discriminating between speech and non-speech; a speech determination unit which, by comparing the aforementioned feature indicating likeliness of being speech with a plurality of aforementioned threshold value candidates, determines respective speech sections, and outputs determination information which is a result of the determination; a search unit which corrects the aforementioned respective speech sections represented by the aforementioned determination information, using a speech model and a non-speech model; and a parameter update unit which estimates a threshold value for determining a speech section, on the basis of distribution profiles of the aforementioned feature respectively for utterance sections and for non-utterance sections, within each of the aforementioned corrected speech sections, and makes an update with the estimated value.

Further, in order to achieve the objective described above, one aspect of a speech recognition method in the present invention includes: extracting a feature indicating likeliness of being speech from a temporal sequence of input sound; generating threshold value candidates for discriminating between speech and non-speech; by comparing the aforementioned feature indicating likeliness of being speech with a plurality of aforementioned threshold value candidates, determining respective speech sections, and outputting determination information which is a result of the determination; correcting the aforementioned respective speech sections represented by the aforementioned determination information, using a speech model and a non-speech model; and estimating a threshold value for determining a speech section, on the basis of distribution profiles of the aforementioned feature respectively for an utterance section and for a non-utterance section, within each of the aforementioned corrected speech sections, and making an update with the estimated value.

Still further, in order to achieve the objective described above, one aspect of a program stored in a recording medium in the present invention causes a computer to execute processes of: extracting a feature indicating likeliness of being speech from a temporal sequence of input sound; generating threshold value candidates for discriminating between speech and non-speech; by comparing the aforementioned feature indicating likeliness of being speech with a plurality of aforementioned threshold value candidates, determining respective speech sections, and outputting determination information which is a result of the determination; correcting the aforementioned respective speech sections represented by the aforementioned determination information, using a speech model and a non-speech model; and estimating a threshold value for determining a speech section, on the basis of distribution profiles of the aforementioned feature respectively for an utterance section and for a non-utterance section, within each of the aforementioned corrected speech sections, and making an update with the estimated value.

### Advantageous Effect of Invention

According to a speech recognition device, a speech recognition method and a program in the present invention, an ideal threshold value can be estimated even when an initially set threshold value deviates far from a proper value.

### BRIEF DESCRIPTION OF THE DRAWINGS

FIG. 1 is a block diagram showing a functional configuration of a speech recognition device 100 in a first exemplary embodiment of the present invention.

FIG. 2 is a flow diagram showing operation of the speech recognition device 100 in the first exemplary embodiment.

FIG. 3 is a diagram showing a temporal sequence of input sound and a temporal sequence of a feature indicating likeliness of being speech.

FIG. 4 is a block diagram showing a functional configuration of a speech recognition device 200 in a second exemplary embodiment of the present invention.

FIG. 5 is a block diagram showing a functional configuration of a speech recognition device 300 in a third exemplary embodiment of the present invention.

FIG. 6 is a block diagram showing a functional configuration of a speech recognition device 400 in a fourth exemplary embodiment of the present invention.

FIG. 7 is a block diagram showing a functional configuration of a speech recognition device described in non-patent document 1.

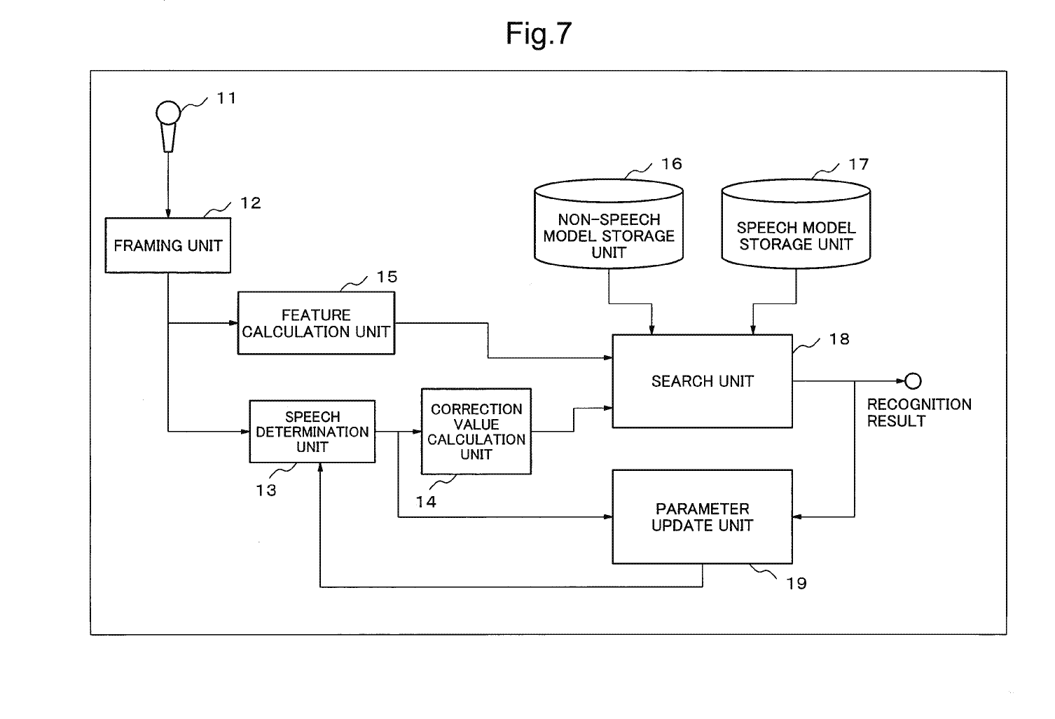

FIG. 8 is a diagram illustrating an example of a method of determining a threshold value disclosed in non-patent document 1.

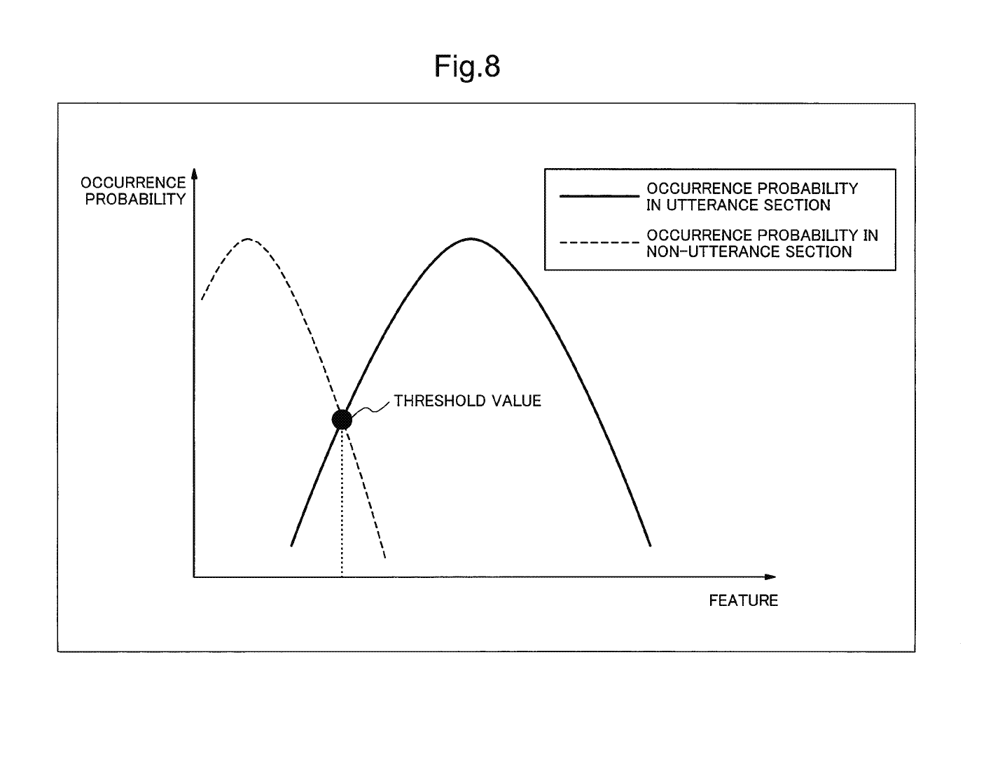

FIG. 9 is a diagram for illustrating a problem in the method of determining a threshold value disclosed in non-patent document 1.

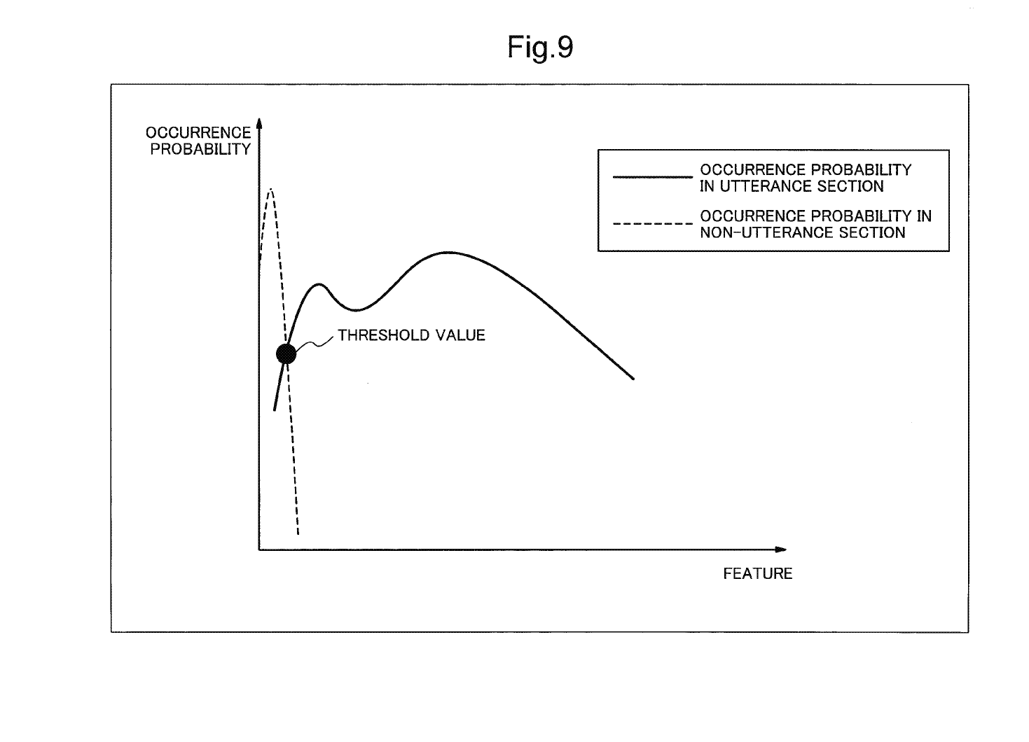

FIG. 10 is a block diagram showing an example of a hardware configuration of a speech recognition device in each exemplary embodiment of the present invention.

### DESCRIPTION OF EMBODIMENTS

Hereinafter, exemplary embodiments of the present invention will be described. Here, units constituting a speech recognition device of each exemplary embodiment are respectively composed of a control unit, a memory, a program loaded on a memory, a storage unit storing a program such as a hard disk, an interface for network connection and the like, which are realized by hardware combined with optional software. Unless otherwise noted, there is no limitation on methods and devices for their realization.

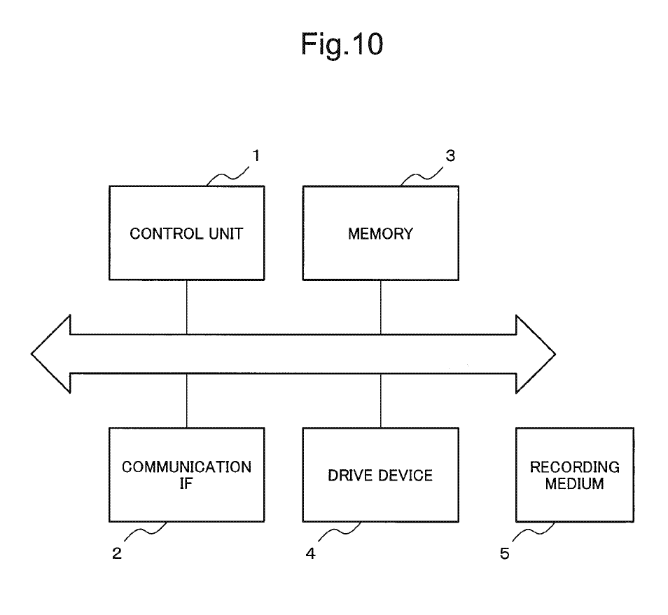

FIG. 10 is a block diagram showing an example of a hardware configuration of a speech recognition device in each exemplary embodiment of the present invention.

A control unit 1 is composed of a CPU (Central Processing Unit; similar in following descriptions) or the like, and causing an operating system to operate, it controls the whole of the respective units of the speech recognition device. The control unit 1 reads out a program and data from a recording medium 5 loaded on a drive device 4, for example, into a memory 3, and executes various kinds of processing according to the program and data.

The recording medium 5 is, for example, an optical disc, a flexible disc, a magneto-optical disc, an external hard disk, a semiconductor memory or the like, which records a computer program in a computer-readable form. Alternatively, the computer program may be downloaded via a communication IF (interface) 2 from an external computer not shown in the diagram which is connected to a communication network.

Here, each block diagram used in a description of each exemplary embodiment does not show a configuration in terms of hardware units, but does show blocks in terms of functional units. These functional blocks are realized by hardware, or software optionally combined with hardware. In these diagrams, units of respective exemplary embodiments may be illustrated such that they are realized by being physically connected in one device, but there is no particular limitation on a unit for realizing them. That is, it is possible, by connecting two or more physically separated devices by wire or wireless, to realize a device of each exemplary embodiment as a system by the use of the plurality of devices.

### First Exemplary Embodiment

First, a functional configuration of a speech recognition device 100 in a first exemplary embodiment will be described.

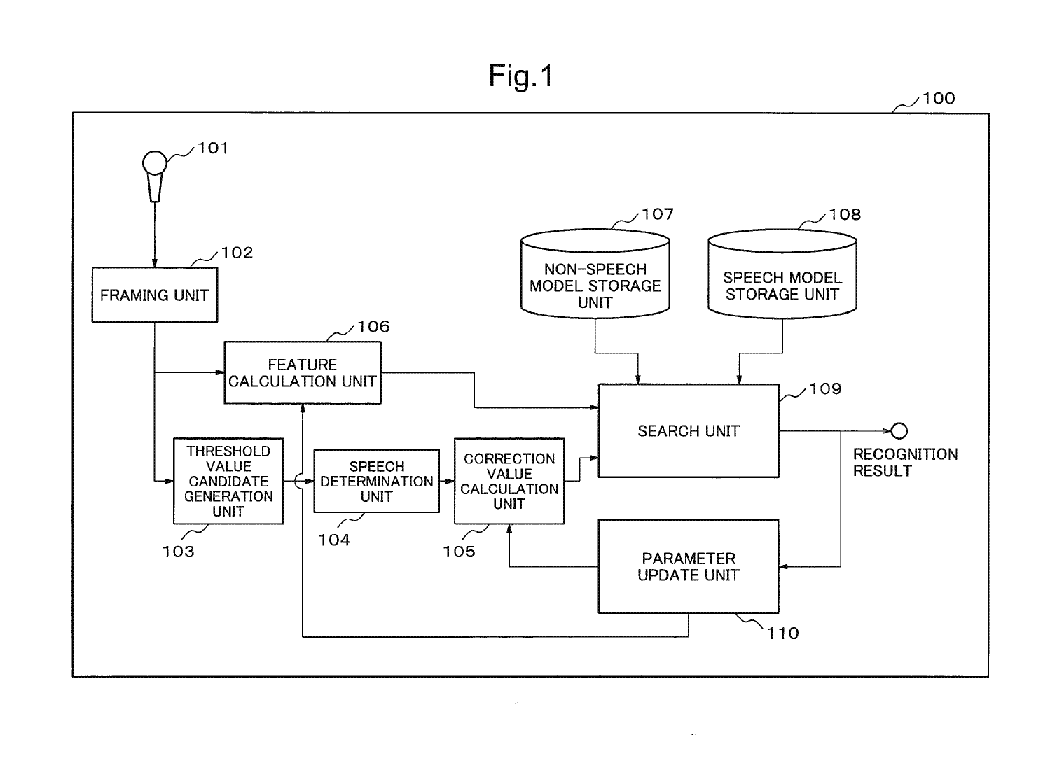

FIG. 1 is a block diagram showing the functional configuration of the speech recognition device 100 in the first exemplary embodiment. As shown in FIG. 1, the speech recognition device 100 includes a microphone 101, a framing unit 102, a threshold value candidate generation unit 103, a speech determination unit 104, a correction value calculation unit 105, a feature calculation unit 106, a non-speech model storage unit 107, a speech model storage unit 108, a search unit 109 and a parameter update unit 110.

The speech model storage unit 108 stores a speech model representing a pattern of vocabulary or phonemes of a speech to be a recognition target.

The non-speech model storage unit 107 stores a non-speech model representing a pattern of other than speeches to be a recognition target.

The microphone 101 collects input sound.

The framing unit 102 cuts out a temporal sequence of input sound collected by the microphone 101 in terms of a frame of a unit of time.

The threshold value candidate generation unit 103 extracts a feature value indicating likeliness of being speech from the temporal sequence of input sound outputted for each frame, and generates a plurality of candidates of a threshold value for discriminating between speech and non-speech. For example, the threshold value candidate generation unit 103 may generate the plurality of threshold value candidates on the basis of a maximum and a minimum feature values for each frame (detailed description will be given later). The feature indicating likeliness of being speech may be a squared amplitude, a signal to noise (S/N) ratio, the number of zero crossings, a GMM (Gaussian mixture model) likelihood ratio, a pitch frequency or the like, and may also be other features The threshold value candidate generation unit 103 outputs the feature value indicating likeliness of being speech for each frame and the plurality of generated threshold value candidates to the speech determination unit 104 as data.

By comparing the feature value indicating likeliness of being speech, extracted by the threshold value candidate generation unit 103, and the plurality of threshold value candidates, the speech determination unit 104 determines speech sections each corresponding to respective ones of the plurality of threshold value candidates. That is, the speech determination unit 104 outputs determination information on whether a speech section or a non-speech section in terms of each of the plurality of threshold value candidates, as a determination result, to the search unit 109. The speech determination unit 104 may output the determination information to the search part 109 via the correction value calculation unit 105, as shown in FIG. 1, or directly to the search unit 109. The determination information is generated in multiple numbers, each corresponding to respective ones of the threshold value candidates, in order to update a threshold value stored in the parameter update unit 110, which will be described later.

From the feature values indicating likeliness of being speech extracted by the threshold value candidate generation unit 103 and a threshold value stored in the parameter update unit 110, the correction value calculation unit 105 calculates a correction value for a likelihood with respect to each model (each of the speech model and non-speech model) The correction value calculation unit 105 may calculate at least either of a correction value for a likelihood with respect to the speech model and that with respect to the non-speech model. The correction value calculation unit 105 outputs the correction value for a likelihood to the search unit 109 for the use in processes of speech recognition and of correction of speech sections, which will be described later.

As the correction value for a likelihood with respect to the speech model, the correction value calculation unit 105 may employ a value obtained by subtracting a threshold value stored in the parameter update unit 110 from a feature value indicating likeliness of being speech. Also, as the correction value for a likelihood with respect to the non-speech model, the correction value calculation unit 105 may employ a value obtained by subtracting a feature value indicating likeliness of being speech from the threshold value (detailed description will be given later).

The feature calculation unit 106 calculates a feature value for speech recognition from a temporal sequence of input sound cut out for each frame. The feature for speech recognition may be various ones such as a well-known spectral power and Mel-frequency spectrum coefficients (MFCC), or their temporal subtraction. Further, the feature for speech recognition may include a feature indicating likeliness of being speech such as squared amplitude and the number of zero crossings, or may be the same one as the feature indicating likeliness of being speech. Furthermore, the feature for speech recognition may be a multiple feature such as of a well-known spectral power and squared amplitude. In following descriptions, the feature for speech recognition will be referred to simply as a “speech feature”, including the feature indicating likeliness of being speech.

The feature calculation unit 106 determines a speech section on the basis of a threshold value stored in the parameter update unit 110, and outputs a speech feature value in the speech section to the search unit 109.

The search unit 109 performs a speech recognition process for outputting a result of the recognition on the basis of the speech feature value and a correction value for a likelihood, and a correction process, for updating a threshold value stored in the parameter update unit 110, on each speech section (each of the speech sections determined by the speech determination unit 104).

First, the speech recognition process will be described. Using the speech feature value in a speech section inputted from the feature calculation unit 106, the speech model stored in the speech model storage unit 108 and the non-speech model stored in the non-speech model storage unit 107, the search unit 109 searches for a word sequence (utterance sound to be a recognition result) corresponding to the temporal sequence of input sound

At that time, the search unit 109 may search for a word sequence for which the speech feature value shows a maximum likelihood with respect to each model. Here, the search unit 109 uses a correction value for a likelihood received from the correction value calculation unit 105. The search unit 109 outputs a retrieved word sequence as a recognition result. In following descriptions, a speech section to which a word sequence (utterance sound) corresponds is referred to as an utterance section, and a speech section not regarded as an utterance section is referred to as a non-utterance segment.

Next, the correction process on a speech section will be described. Using a feature value indicating likeliness of being speech, the speech models and the non-speech models, the search unit 109 performs correction on each speech section represented by determination information from the speech determination unit 104. That is, the search unit 109 repeats the correction process on a speech section the number of times equal to the number of the threshold value candidates generated by the threshold value candidate generation unit 103. Detail of the correction process on a speech section performed by the search unit 109 will be described later.

The parameter update unit 110 creates histograms from each of the speech sections corrected at the search unit 109, and updates a threshold value to be used at the correction value calculation unit 105 and the feature calculation unit 106. Specifically, the parameter update unit 110 estimates a threshold value from distribution profiles of the feature indicating likeliness of being speech respectively of utterance sections and of non-utterance sections, in each of the corrected speech sections, and makes an update with the estimated value.

The parameter update unit 110 may calculate a threshold value, with respect to each of the corrected speech sections, from histograms of the feature indicating likeliness of being speech respectively of utterance sections and of non-utterance sections, and then estimating an average of the plurality of threshold values to be a new threshold value, it may make an update with the new threshold value. Further, the parameter update unit 110 stores the updated parameters, and provides them as necessary to the correction value calculation unit 105 and the feature calculation unit 106.

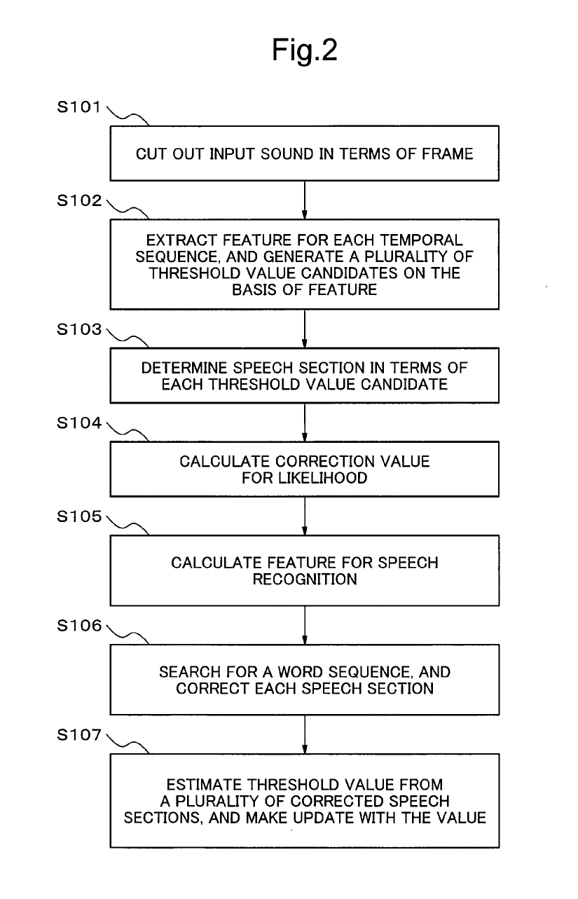

Next, with reference to FIG. 1 and a flow diagram in FIG. 2, operation of the speech recognition device 100 in the first exemplary embodiment will be described.

FIG. 2 is a flow diagram showing operation of the speech recognition device 100 in the first exemplary embodiment. As shown in FIG. 2, first, the microphone 101 collects input sound, and subsequently, the framing unit 102 cuts out a temporal sequence of input sound in terms of a frame of a unit of time (step S101).

Next, the threshold value candidate generation unit 103 extracts a feature value indicating likeliness of being speech from each of the temporal sequences cut out for respective frames, and generates a plurality of threshold value candidates on the basis of the values of the feature (step S102).

Next, by comparing the values of the feature indicating likeliness of being speech extracted by the threshold value candidate generation unit 103 with each of the plurality of threshold value candidates generated by the threshold value candidate generation unit 103, the speech determination unit 104 determines speech sections in terms of each of the threshold value candidates and outputs the determination information (step S103).

Next, the correction value calculation unit 105 calculates a correction value for a likelihood with respect to each model from the feature values indicating likeliness of being speech and a threshold value stored in the parameter update unit 110 (step S104).

Next, the feature calculation unit 106 calculates a speech feature value from a temporal sequence of input sound cut out for each frame by the framing unit 102 (step S105).

Next, the search unit 109 performs a speech recognition process and a correction process on speech sections. That is, the search unit 109 performs speech recognition (searching for a word sequence), thus outputting a result of the speech recognition, and corrects the speech sections in terms of each threshold value candidate, which were represented as determination information at the step S103, using a feature value indicating likeliness of being speech for each frame, a speech model and a non-speech model (step S106).

Next, the parameter update unit 110 estimates a threshold value (ideal threshold value) from the plurality of speech sections corrected by the search unit 109, and makes an update with the value (step S107).

Hereinafter, detailed description will be given of each of the steps described above.

First, description will be given of a process of cutting out a temporal sequence of collected input sound in terms of a frame of a unit of time, which is performed by the framing unit 102 at the step S101. For example, when input sound data is in the form of a 16 bit Linear-PCM signal with a sampling frequency of 8000 Hz, waveform data with 8000 points a second is stored. It is supposed such as that the framing unit 102 sequentially cuts this waveform data into frames each having a width of 200 points (25 milliseconds) and a frame shift of 80 points (10 milliseconds), according to the temporal sequence.

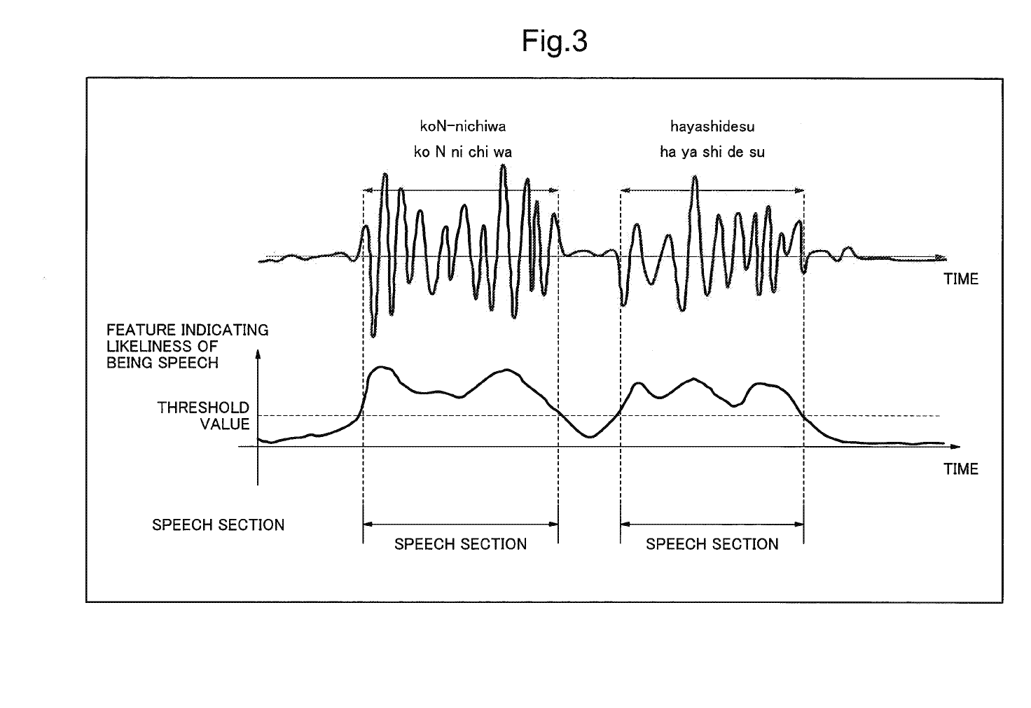

Next, the step S102 will be described in detail. FIG. 3 is a diagram showing a temporal sequence of input sound and a temporal sequence of the feature indicating likeliness of being speech. As shown in FIG. 3, the feature indicating likeliness of being speech may be, for example, squared amplitude or the like. A squared amplitude xt may be calculated by an equation 1 shown below (in the equation 1, t is written as a subscript).

$${x}_{t} = \frac{1}{N} {\sum }_{{t}^{′} = t}^{t + N - 1} {s}_{{t}^{′}}^{2} \qquad ( Equation 1 )$$

Here, St is a value of input sound data (waveform data) at a time t. Although squared amplitude is employed in FIG. 3, the feature indicating likeliness of being speech may be other ones, as described before, such as the number of zero crossings, a likelihood ratio between a speech and a non-speech models, a pitch frequency or an S/N ratio. The threshold value candidate generation unit 103 may generate a plurality of threshold value candidates by calculating a plurality of θi using an equation 2 in terms of a speech section and a non-speech section within a certain interval.

$$d = \frac{{f}_{max} - {f}_{min}}{N} \\ {θ}_{i} = {f}_{min} + d \times i \\ ( i = 1 , 2 , … N - 1 ) \qquad ( Equation 2 )$$

Here, fmin is the minimum feature value in the above-mentioned speech and non-speech sections within the certain interval. The fmax is the maximum feature value in the above-mentioned speech and non-speech sections within the certain interval. N is the number for dividing the certain interval into the speech and non-speech sections. When a more accurate threshold value is desired, a user may set N at a larger value. When noise environment becomes stable and thus variation in threshold value becomes non-existent, the threshold value candidate generation unit 103 may end the process. That is, in that case, the speech recognition device 100 may end the process of updating a threshold value.

Next, the step S103 will be described with reference to FIG. 3. As shown in FIG. 3, if a value of the squared amplitude (feature indicating likeliness of being speech) of a section is larger than a threshold value, the section is more likely to be of speech than of non-speech, and thus the speech determination unit 104 determines the section to be a speech section. If a value of the squared amplitude is smaller than a threshold value, the section is more likely to be of non-speech, and thus the speech determination unit 104 determines the section to be a non-speech section. As already described before, although a squared amplitude is employed in FIG. 3, the feature indicating likeliness of being speech may be other ones, as described above, such as the number of zero crossings, a likelihood ratio between a speech and a non-speech models, a pitch frequency or an S/N ratio. Here, threshold values used at the step S103 are the values of a plurality of threshold value candidates θi generated by the threshold value candidate generation unit 103. The step S103 is repeated the number of times equal to the number of the plurality of threshold value candidates. Next, the step S104 will be described in detail. A correction value for a likelihood calculated by the correction value calculation unit 105 functions as a correction value for a likelihood with respect to a speech model or a non-speech model which is calculated by the search unit 109 at the step S106. The correction value calculation unit 105 may calculate a correction value for a likelihood with respect to a speech model by, for example, an equation 3.

correction value=w×(xt−θ) (Equation 3)

Here, w is a factor about a correction value, which takes a positive real number. The θ at the present step S104 is a threshold value stored in the parameter update unit 110. The correction value calculation unit 105 may calculate a correction value for a likelihood with respect to a non-speech model by, for example, an equation 4.

correction value=w×(θ−xt) (Equation 4)

Although the example shown here is one calculating a correction value being a linear function of the feature (squared amplitude) xt, other methods may be used as a method for calculating a correction value as long as they give a correct magnitude relationship. For example, the correction value calculation unit 105 may calculate a correction value for a likelihood by equations 5 and 6 where the equations 3 and 4 are respectively modified using a logarithmic function.

correction value=log{w×(xt−θ)} (Equation 5)

correction value=log{w×(θ−xt)} (Equation 6)

Although the correction value calculation unit 105 calculates, in the present example, a correction value for a likelihood with respect to both speech and non-speech models, it may calculate only with respect to either of the models, thus setting the other at zero.

Alternatively, the correction value calculation unit 105 may set at zero a correction value for a likelihood with respect to both speech and non-speech models. In that case, the speech recognition device 100 may be configured such that it does not comprise the correction value calculation unit 105, and the speech determination unit 104 inputs a result of its speech determination directly to the search unit 109.

Next, the step S106 will be described in detail. At the step S106, the search unit 109 corrects each speech section using a feature value indicating likeliness of being speech for each frame and speech and non-speech models. The process of the step S106 is repeated the number of times equal to the number of threshold value candidates generated in the threshold value candidate generation unit 103.

Further, as a speech recognition process, the search unit 109 searches for a word sequence corresponding to a temporal sequence of input sound data, using a value of a speech feature for each frame calculated by the feature calculation unit 106.

A speech model and a non-speech model stored respectively in the speech model storage unit 108 and in the non-speech model storage unit 107 may be a well-known hidden Markov model or the like. A parameter of the models is set in advance through learning on a temporal sequence of standard input sound. In the present example, it is supposed that the speech recognition device 100 performs the speech recognition process and the speech section correction process using a logarithmic likelihood as a measure of a distance between a speech feature value and each model.

Here, a logarithmic likelihood of a temporal sequence of the speech feature for each frame with respect to a speech model representing each vocabulary or phonemes included in speech is defined as Ls(j,t). The j represents one state of the speech model. The search unit 109 corrects the logarithmic likelihood as in the following equation 7, using a correction value given by the equation 3 described above.

Ls(j,t)←Ls(j,t)+w×(xt−θ) (Equation 7)

Similarly, a logarithmic likelihood of a temporal sequence of the speech feature for each frame with respect to a model representing each vocabulary or phonemes included in non-speech is defined as Ln(j,t). The j represents one state of the non-speech model. The search unit 109 corrects the logarithmic likelihood as in the following equation 8, using a correction value given by the equation 4 mentioned above.

Ln(j, t)←Ln(j, t)+w×(θ−xt) (Equation 8)

By searching for one giving a maximum likelihood among temporal sequences of the corrected logarithmic likelihoods, the search unit 109 searches for a word sequence corresponding to a speech section in the temporal sequence of input sound that determined by the feature calculation unit 106, as shown in the upper area of FIG. 3 (speech recognition process). Further, the search unit 109 corrects each of the speech sections determined at the speech determination unit 104. About each of the speech sections, the search unit 109 determines a section for which a corrected logarithmic likelihood with respect to the speech model (a value given by the equation 7) is higher than that with respect to the non-speech model (a value given by the equation 8) to be a corrected speech section (speech section correction process).

Next, the step S107 will be described in detail. In order to estimate an ideal threshold value, the parameter update unit 110 classifies each of the corrected speech sections into a group of utterance sections and that of non-utterance sections, and creates data which represents feature values indicating likeliness of being speech for each of the groups in the form of a histogram. As mentioned above, an utterance section is a speech section to which a word sequence (utterance sound) corresponds. A non-utterance section is a speech section not being an utterance section. Here, if a point of intersection of a histogram for utterance sections with that for non-utterance sections is expressed by θi with a hat, the parameter update unit 110 may estimate an ideal threshold value by calculating an average of a plurality of threshold values by an equation 9.

$$θ = \frac{\sum {\hat{θ}}_{i}}{N} \\ ( i = 1 , 2 , 3 … , N - 1 ) \qquad ( Equation 9 )$$

N is a dividing number equal to N in the equation 2.

As has been described above, according to the speech recognition device 100 in the first exemplary embodiment, an ideal threshold value can be estimated even when an initially set threshold value deviates far from a proper value. That is, the speech recognition device 100 corrects speech sections determined on the basis of a plurality of threshold values generated in the threshold value candidate generation unit 103. Then, by calculating an average of threshold values each obtained as a point of intersection of histograms calculated using each of the corrected speech sections, the speech recognition device 100 estimates a threshold value; which is the reason of the capability of estimating an ideal threshold value.

Further, the speech recognition device 100 can estimate a more ideal threshold value by comprising the correction value calculation unit 105. That is, in the speech recognition device 100, using a threshold value updated by the parameter update unit 110, the correction value calculation unit 105 calculates a correction value. Then, using the calculated correction value, the speech recognition device 100 corrects a likelihood with respect to a non-speech model and that with respect to a speech model, and thus can determine a more precise utterance section; which is the reason of the capability of estimating a more ideal threshold value.

As a result, the speech recognition device 100 can perform speech recognition and threshold value estimation robustly against noise and in real time.

### Second Exemplary Embodiment

Next, a functional configuration of a speech recognition device 200 in a second exemplary embodiment will be described.

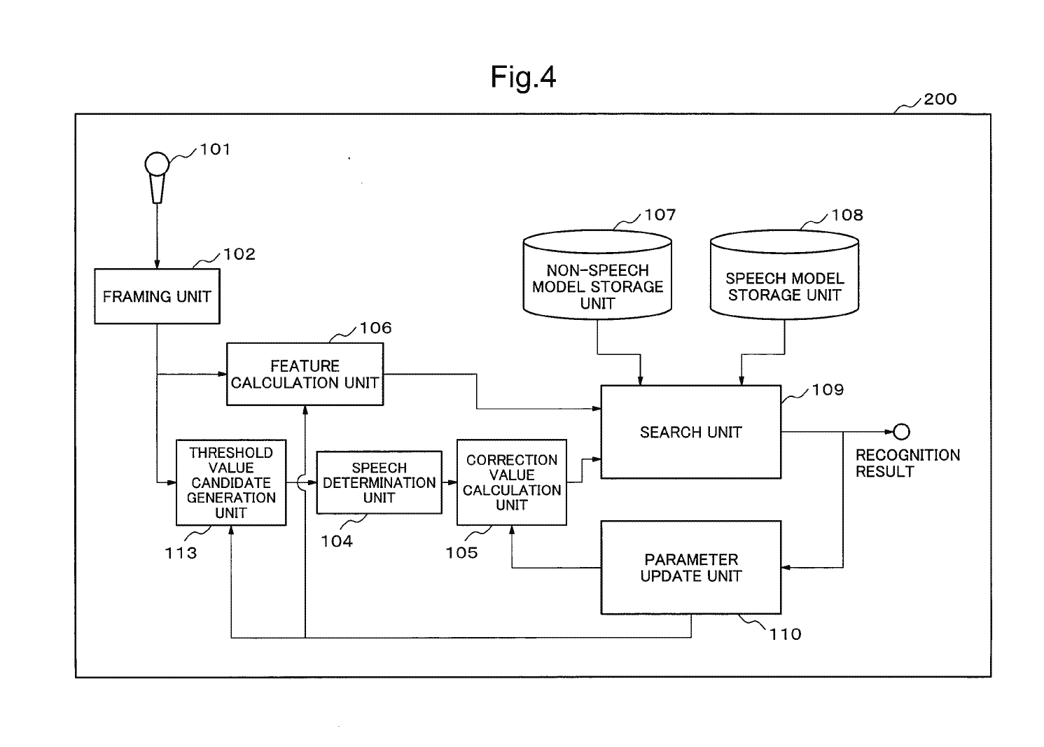

FIG. 4 is a block diagram showing a functional configuration of the speech recognition device 200 in the second exemplary embodiment. As shown in FIG. 4, comparing with the speech recognition device 100, the speech recognition system 200 is different in that it includes a threshold value candidate generation unit 113 in place of the threshold value candidate generation unit 103

The threshold value candidate generation unit 113 generates a plurality of threshold value candidates, taking a threshold value updated in the parameter update unit 110 as a reference. The plurality of generated threshold value candidates may be a plurality of values which are sequentially separated at constant intervals with reference to a threshold value updated in the parameter update unit 110.

Operation of the speech recognition device 200 in the second exemplary embodiment will be described with reference to FIG. 4 and the flow chart in FIG. 2.

Compared to the operation of the speech recognition device 100, the operation of the speech recognition device 200 is different in the step S102 in FIG. 2.

At the step S102, the threshold value candidate generation unit 113 receives a threshold value inputted from the parameter update unit 110. The threshold value may be an updated, latest threshold value. Taking the threshold value inputted from the parameter update unit 110 as a reference, the threshold value candidate generation unit 113 generates threshold values around the reference value as threshold value candidates, and inputs the plurality of generated threshold value candidates to the speech determination unit 104. The threshold value candidate generation unit 113 may generate threshold value candidates by calculating them from the threshold value inputted from the parameter update unit 110 by an equation 10.

θⱼ=θ₀±θᵢ(i=0,1,2 . . . N−1) (Equation 10)

Here, θ0 is the threshold value inputted from the parameter update unit 110, and N is the dividing number. The threshold value candidate generation unit 113 may take a larger N value so as to calculate more accurate values. When the estimation of a threshold value becomes stable, the threshold value candidate generation unit 113 may decrease N. The threshold value candidate generation unit 113 may calculate θi in the equation 10 by an equation 11.

$$d = \frac{2 {θ}_{0}}{N} \\ {θ}_{i} = d \times i \\ ( i = 0 , 1 , 2 , … N - 1 ) \qquad ( Equation 11 )$$

Here, N is a dividing number equal to N in the equation 10. Alternatively, the threshold value candidate generation unit 113 may calculate θi in the equation 10 by an equation 12.

θᵢ=D×i(i=0,1,2, . . . N−1) (Equation 12)

D is a constant which is appropriately determined.

As has been described above, according to the speech recognition device 200 in the second exemplary embodiment, by taking a threshold value of the parameter update unit 110 as a reference, an ideal threshold value can be estimated even with a small number of threshold value candidates.

### Third Exemplary Embodiment

Next, a functional configuration of a speech recognition device 300 in a third exemplary embodiment will be described.

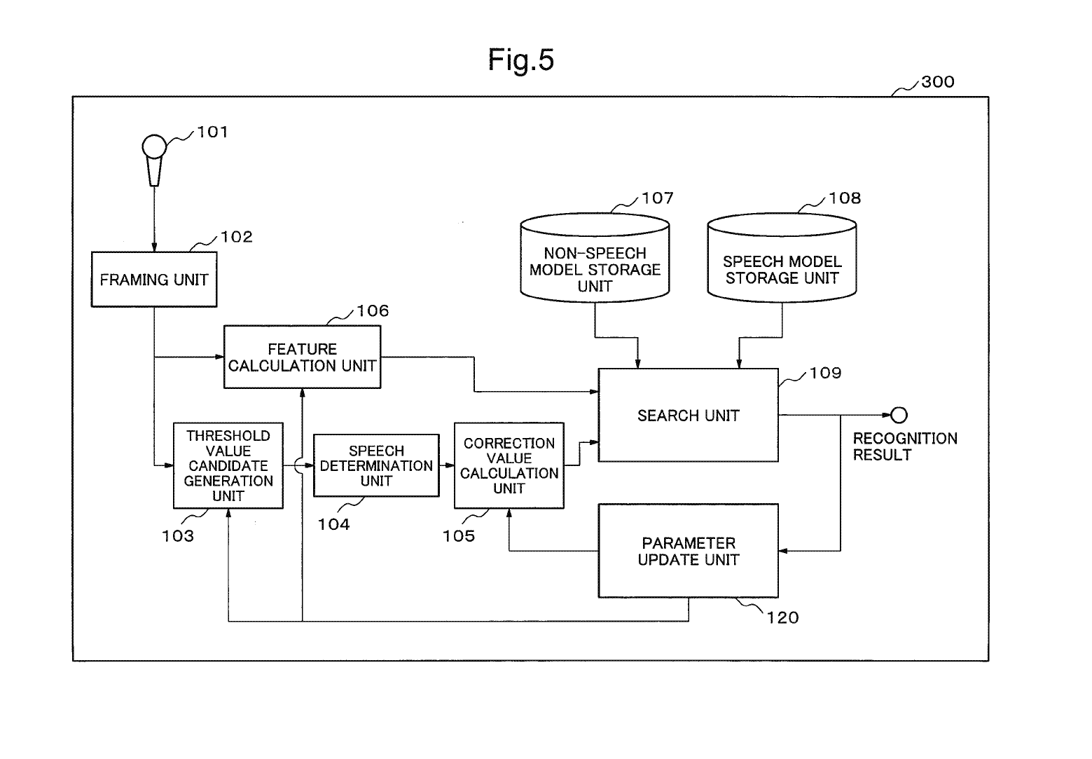

FIG. 5 is a block diagram showing a functional configuration of the speech recognition device 300 in the third exemplary embodiment. As shown in FIG. 5, comparing with the speech recognition device 100, the speech recognition device 300 is different in that it includes a parameter update unit 120 in place of the parameter update unit 110

The parameter update unit 120 calculates a new threshold value to update with, by applying a weighting scheme to the calculation, in the second exemplary embodiment, of an average of threshold values obtained from histograms representing feature values indicating likeliness of being speech. That is, the new threshold value which the parameter update unit 120 estimates is a weighted average of intersection points of histograms each created from respective corrected speech sections.

Operation of the speech recognition device 300 in the third exemplary embodiment will be described with reference to FIG. 5 and the flow chart in FIG. 2.

Compared to the operation of the speech recognition device 100, the operation of the speech recognition device 300 is different in the step S107 in FIG. 2.

At the step S107, the parameter update unit 120 estimates an ideal threshold value from a plurality of speech sections corrected by the search unit 109. Similarly to in the first exemplary embodiment, it classifies each of the corrected speech sections into a group of utterance sections and a group of non-utterance sections, and creates data, for each of the section groups, in which values of a feature indicating likeliness of being speech are represented by a histogram. Here, it is supposed that, about each set of the corrected speech sections, a point of intersection of a histogram of utterance sections with that of non-utterance sections is expressed by θj with a hat. The parameter update unit 120 may estimate an ideal threshold value by calculating, by an equation 13, an average of a plurality of threshold values with a weighting scheme.

$$θ = \frac{\sum {ω}_{j} {\hat{θ}}_{j}}{N} \\ ( j = 1 , 2 , 3 … , N - 1 ) \qquad ( Equation 13 )$$

N is a dividing number equal to N in the equation 10. The wj is a weight applied to θj with a hat expressing a point of intersection of histograms. Although there is no particular restriction on a way of determining wj, it may be increased with increasing a value of j.

As has been described above, according to the speech recognition device 300 in the third exemplary embodiment, as a result of the parameter update unit 120 calculating an average value with a weighting scheme, it becomes possible to calculate a more stable threshold value.

### Fourth Exemplary Embodiment

Next, a functional configuration of a speech recognition device 400 in a fourth exemplary embodiment will be described.

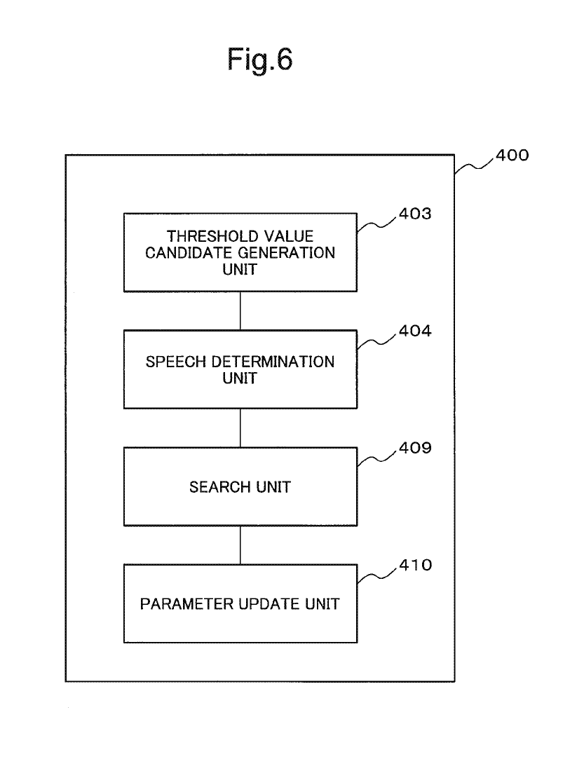

FIG. 6 is a block diagram showing a functional configuration of the speech recognition device 400 in the fourth exemplary embodiment. As shown in FIG. 6, the speech recognition device 400 includes a threshold value candidate generation unit 403, a speech determination unit 404, a search unit 409 and a parameter update unit 410.

The threshold value candidate generation unit 403 extracts a feature value indicating likeliness of being speech from a temporal sequence of input sound, and generates a plurality of threshold value candidates for discriminating between speech and non-speech.

By comparing the feature value indicating likeliness of being speech with the plurality of threshold value candidates, the speech determination unit 404 determines speech sections in terms of each of the threshold value candidates.

The search unit 409 corrects each of the speech sections using a speech model and a non-speech model.

The parameter update unit 410 estimates a threshold value from distribution profiles of the feature respectively in utterance sections and in non-utterance sections, within each of the corrected speech sections, and makes an update with the threshold value.

As has been described above, according to the speech recognition device 400 in the fourth exemplary embodiment, an ideal threshold value can be estimated even when an initially set threshold value deviates far from a proper value.

It should be understood that the exemplary embodiments described above are not ones limiting the technical scope of the present invention. Further, configurations described in the respective exemplary embodiments can be combined with each other within the scope of the technical concept of the present invention. For example, a speech recognition device may comprise a threshold value candidate generation unit 113 in the second exemplary embodiment in place of a threshold value candidate generation unit 103, and may comprise a parameter update unit 120 in the third exemplary embodiment in place of a parameter update unit 110. In such cases, the speech recognition devices come to be able to estimate a more stable threshold value with a smaller number of threshold value candidates.

### Other Expressions of Exemplary Embodiment

In the above-described exemplary embodiments, characteristic configurations of a speech recognition device, a speech recognition method and a program, which will be described below, have been shown (but they are not limited to the followings). Here, a program of the present invention may be any program causing a computer to execute each operation described in the above-described exemplary embodiments.

### Further Exemplary Embodiment 1

A speech recognition device comprising:

a threshold value candidate generation unit which extracts a feature indicating likeliness of being speech from a temporal sequence of input sound, and generates a threshold value candidate for discriminating between speech and non-speech;

a speech determination unit which, by comparing said feature indicating likeliness of being speech with a plurality of said threshold value candidates, determines respective speech sections, and outputs determination information as a result of the determination;

a search unit which corrects each of said speech sections represented by said determination information using a speech model and a non-speech model; and

a parameter update unit which estimates a threshold value for determining a speech section, on the basis of distribution profiles of said feature respectively in utterance sections and in non-utterance sections, within each of said corrected speech sections, and makes an update with the threshold value.

### Further Exemplary Embodiment 2

The speech recognition device according to further exemplary embodiment 1, wherein said threshold value candidate generation unit generates a plurality of threshold value candidates from values of said feature indicating likeliness of being speech.

### Further Exemplary Embodiment 3

The speech recognition device according to further exemplary embodiment 2, wherein

said threshold value candidate generation unit generates a plurality of threshold value candidates on the basis of a maximum value and a minimum value of said feature.

### Further Exemplary Embodiment 4

The speech recognition device according to any one of further exemplary embodiments 1-3, wherein

said parameter update unit calculates, with respect to each of the corrected speech sections outputted by said search unit, a point of intersection of histograms of said feature respectively in utterance sections and in non-utterance sections, and thus estimates an average of a plurality of said points of intersection to be a new threshold value, and makes an update with the new threshold value.

### Further Exemplary Embodiment 5

The speech recognition device according to one of further exemplary embodiments 1-4, further comprising:

a speech model storage unit which stores a speech (vocabulary or phonemes) model representing a speech to be a target of recognition; and

a non-speech model storage unit which stores a non-speech model representing other than speeches to be targets of recognition; wherein

said search unit calculates a likelihood of said speech model and that of said non-speech model with respect to a temporal sequence of input speech, and searches for a word sequence giving a maximum likelihood.

### Further Exemplary Embodiment 6

The speech recognition device according to further exemplary embodiment 5, further comprising

a correction value calculation unit which calculates from said feature for recognition at least either a correction value for a likelihood with respect to said speech model or that with respect to said non-speech model, wherein

said search unit corrects said likelihood on the basis of said correction value.

### Further Exemplary Embodiment 7

The speech recognition device according to further exemplary embodiment 6, wherein

said correction value calculation unit employs a value obtained by subtracting a threshold value from said feature as said correction value of a likelihood with respect to a speech model, and a value obtained by subtracting said feature from a threshold value as said correction value of a likelihood to a non-speech model.

### Further Exemplary Embodiment 8

The speech recognition device according to any one of further exemplary embodiments 1-7, wherein:

said feature indicating likeliness of being speech is at least one of a squared amplitude, a signal to noise ratio, the number of zero crossings, a GMM likelihood ratio and a pitch frequency; and

said feature for recognition is at least one of a well-known spectral power, Mel-frequency cepstrum coefficients (MFCC) or their temporal subtraction, and includes said feature indicating likeliness of being speech.

### Further Exemplary Embodiment 9

The speech recognition device according to any one of further exemplary embodiments 1-8, wherein

said threshold value candidate generation unit generates a plurality of threshold value candidates, taking a threshold value updated by said parameter update unit as a reference.

### Further Exemplary Embodiment 10

The speech recognition device according to further exemplary embodiment 4, wherein

said average of threshold values which is to be a new threshold value estimated by said parameter update unit is a weighted average of said threshold values.

### Further Exemplary Embodiment 11

A speech recognition method comprising:

extracting a feature indicating likeliness of being speech from a temporal sequence of input sound, and generating a threshold value candidate for discriminating between speech and non-speech;

determining respective speech sections by comparing said feature indicating likeliness of being speech with a plurality of said threshold value candidates, and outputting determination information as a result of the determination;

correcting said respective speech sections represented by said determination information using a speech model and a non-speech model; and

estimating a threshold value for speech section determination on the basis of distribution profiles of said feature respectively in utterance sections and in non-utterance sections, within each of said corrected speech sections.

### Further Exemplary Embodiment 12

A recording medium which stores a program for causing a computer to execute processes of:

extracting a feature indicating likeliness of being speech from a temporal sequence of input sound, and generating a threshold value candidate for discriminating between speech and non-speech; determining respective speech sections by comparing said feature indicating likeliness of being speech with a plurality of said threshold value candidates, and outputting determination information as a result of the determination;

correcting said respective speech sections represented by said determination information using a speech model and a non-speech model; and

estimating a threshold value for speech section determination on the basis of distribution profiles of said feature respectively in utterance sections and in non-utterance sections, within each of said corrected speech sections.

This application is based upon and claims the benefit of priority from Japanese patent application No. 2010-209435, filed on Sep. 17, 2010, the disclosure of which is incorporated herein in its entirety by reference.

### REFERENCE SIGNS LIST

1 control unit

2 communication IF

3 memory

4 drive device

5 recording medium

11 microphone

12 framing unit

13 speech determination unit

14 correction value calculation unit

15 feature calculation unit

16 non-speech model storage unit

17 speech model storage unit

18 search unit

19 parameter update unit

100 speech recognition device

101 microphone

102 framing unit

103 threshold value candidate generation unit

104 speech determination unit

105 correction value calculation unit

106 feature calculation unit

107 non-speech model storage unit

108 speech model storage unit

109 search unit

110 parameter update unit

113 threshold value candidate generation unit

120 parameter update unit

200 speech recognition device

300 speech recognition device

400 speech recognition device

403 threshold value candidate generation unit

404 speech determination unit

409 search unit

410 parameter update unit

What is claimed is:

1-10. (canceled)

11. A speech recognition device comprising:
a threshold value candidate generation unit which extracts a feature indicating likeliness of being speech from a temporal sequence of input sound, and generates a threshold value candidate for discriminating between speech and non-speech;
a speech determination unit which, by comparing said feature indicating likeliness of being speech with a plurality of said threshold value candidates, determines respective speech sections and outputs determination information as a result of the determination;
a search unit which corrects each of said speech sections represented by said determination information using a speech model and a non-speech model; and
a parameter update unit which estimates a threshold value for determining a speech section, on the basis of distribution profiles of said feature respectively in utterance sections and in non-utterance sections, within each of said corrected speech sections, and makes an update with the threshold value.

12. The speech recognition device according to claim 11, wherein said threshold value candidate generation unit generates a plurality of threshold value candidates from values of said feature indicating likeliness of being speech.

13. The speech recognition device according to claim 12, wherein
said threshold value candidate generation unit generates a plurality of threshold value candidates on the basis of a maximum value and a minimum value of said feature.

14. The speech recognition device according to any one of claims 11-13, wherein
said parameter update unit calculates, with respect to each of the corrected speech sections outputted by said search unit, a point of intersection of histograms of said feature respectively in utterance sections and in non-utterance sections, and thus estimates an average of a plurality of said points of intersection to be a new threshold value, and makes an update with the new threshold value.

15. The speech recognition device according to any one of claims 11-14, further comprising:
a speech model storage unit which stores a speech (vocabulary or phonemes) model representing a speech to be a target of recognition; and
a non-speech model storage unit which stores a non-speech model representing other than speeches to be targets of recognition; wherein
said search unit calculates a likelihood of said speech model and that of said non-speech model with respect to a temporal sequence of input speech, and searches for a word sequence giving a maximum likelihood.

16. The speech recognition device according to claim 15, further comprising
a correction value calculation unit which calculates from said feature for recognition at least either a correction value for a likelihood with respect to said speech model or that with respect to said non-speech model, wherein
said search unit corrects said likelihood on the basis of said correction value.

17. The speech recognition device according to any one of claims 11-16, wherein
said threshold value candidate generation unit generates a plurality of threshold value candidates, taking a threshold value updated by said parameter update unit as a reference.

18. The speech recognition device according to claim 14, wherein
said average of threshold values which is to be a new threshold value estimated by said parameter update unit is a weighted average of said threshold values.

19. A speech recognition method comprising:
extracting a feature indicating likeliness of being speech from a temporal sequence of input sound, and generating a threshold value candidate for discriminating between speech and non-speech;
determining respective speech sections by comparing said feature indicating likeliness of being speech with a plurality of said threshold value candidates, and outputting determination information as a result of the determination;
correcting said respective speech sections represented by said determination information using a speech model and a non-speech model; and
estimating a threshold value for speech section determination on the basis of distribution profiles of said feature respectively in utterance sections and in non-utterance sections, within each of said corrected speech sections, and making an update with the threshold value.

20. A non-transitory computer - readable medium A recording medium which stores a program for causing a computer to execute processes of:
extracting a feature indicating likeliness of being speech from a temporal sequence of input sound, and generating a threshold value candidate for discriminating between speech and non-speech;
determining respective speech sections by comparing said feature indicating likeliness of being speech with a plurality of said threshold value candidates, and outputting determination information as a result of the determination;
correcting said respective speech sections represented by said determination information using a speech model and a non-speech model; and
estimating a threshold value for speech section determination on the basis of distribution profiles of said feature respectively in utterance sections and in non-utterance sections, within each of said corrected speech sections, and making an update with the threshold value.

21. A speech recognition device comprising:
a threshold value candidate generation means for extracting a feature indicating likeliness of being speech from a temporal sequence of input sound, and generating a threshold value candidate for discriminating between speech and non-speech;
a speech determination means for determining respective speech sections by comparing said feature indicating likeliness of being speech with a plurality of said threshold value candidates, and outputting determination information as a result of the determination;
a search means for correcting each of said speech sections represented by said determination information using a speech model and a non-speech model; and
a parameter update means for estimating a threshold value for determining a speech section, on the basis of distribution profiles of said feature respectively in utterance sections and in non-utterance sections, within each of said corrected speech sections, and making an update with the threshold value.
